(19) United States
(12) Patent Application Publication
(10) Pub. No.: US 2017/0330118 A1
(43) Pub. Date: Nov. 16, 2017

(54) CAPABILITY ASSESSMENT TOOL

(71) Applicant: Accenture Global Solutions Limited, Dublin (IE)

(72) Inventors: Michael Brombach, Minneapolis, MN (US); Leslie Basham, Chicago, IL (US); Michael Ostergard, Marietta, GA (US); Kristin Ficery, Atlanta, GA (US)

(21) Appl. No.: 15/152,767

(22) Filed: May 12, 2016

(51) Int. Cl. G06Q 10/06

(52) U.S. Cl. CPC G06Q 10/0637; G06Q 10/06393

(57) ABSTRACT

Methods, systems, and apparatuses, including computer programs encoded on a computer storage medium, can be implemented to perform actions for assessing a capability of an organization. The actions can include receiving multiple normalization factors associated with raw consumer data related to the capability of the organization, generating normalized consumer data related to the capability of the organization based on the multiple normalization factors associated with the raw consumer data, generating a graph illustrating the normalized consumer data with respect to a performance of a market including the organization and one or more competitors of the organization such that the graph provides an assessment of the capability of the organization, and outputting the graph to a processing device for display of the graph to effect an organizational decision based on the assessment.

### BACKGROUND

In some industries, an entity may desire to examine its capabilities in efforts to meet continually evolving customer demands and to improve its capabilities. In some examples, key performance indicators related to capabilities of the entity may be examined using a variety of subjective survey techniques and data collection methodologies. For example, customers of the entity may be surveyed for anecdotal insights regarding their experiences with the entity and their experiences with other entities. In some cases, decision-makers associated with the entity may focus more efforts on certain capabilities than on other capabilities. In some examples, capability analyses can be used to effect business decisions for entities in a variety of industries.

### SUMMARY

Implementations of the present disclosure are generally directed to a computer-implemented framework for processing data related to capabilities of multiple entities in order to effect changes in the capabilities of one of the multiple entities. For example, data of a first format (e.g., a raw format) can be processed to generate transformation data (e.g., conversion data) of a second format (e.g. a normalized format), such that the capabilities of the multiple entities can be compared or otherwise examined according to a normalized evaluation scheme based on the transformation data of the second format. Based on results produced by the normalized evaluation scheme, implementations of the present disclosure can generate outputs that provide assessments of the capabilities of one or more of the multiple entities. Such assessments can be used to effect a process change associated with one of the multiple entities to achieve a desired result.

For example, implementations of the present disclosure include computer-implemented methods for assessing the capability of an organization. The computer-implemented methods are executed by one or more processors and include the actions of receiving multiple normalization factors associated with raw consumer data related to the capability of the organization, generating normalized consumer data related to the capability of the organization based on the multiple normalization factors associated with the raw consumer data, generating a graph illustrating the normalized consumer data with respect to a performance of a market including the organization and one or more competitors of the organization such that the graph provides an assessment of the capability of the organization, and outputting the graph to a processing device for display of the graph to effect an organizational decision based on the assessment. Other implementations of the present disclosure include corresponding systems, apparatuses, and computer programs encoded on computer storage devices that are configured to perform the actions of the computer-implemented method.

These and other implementations can each optionally include one or more of the following features. In some implementations, the raw consumer data includes one or both of subjective data and objective data. In some implementations, the raw consumer data includes one or both of qualitative data and quantitative data. In some implementations, the normalized consumer data includes quantitative data. In some implementations, the multiple normalization factors include numerical ratings. In some implementations, the numerical ratings include one or more of integer ratings of the raw consumer data and percentage ratings of the raw consumer data. In some implementations, the capability is a personalization capability, an access capability, a transparency capability, a consumer power capability, a multi-channel capability, or a disintermediation capability. In some implementations, the organization is a healthcare organization. In some implementations, the capability includes multiple sub-capabilities that reflect one or more key performance indicators. In some implementations, the raw consumer data and the normalized consumer data reflect a first consumer perspective of the organization and a second consumer perspective of the one or more competitors of the organization.

In some implementations, the capability is a first capability, the raw consumer data is further related to a second capability and a third capability of the organization, and the normalized consumer data is further related to the second and third capabilities of the organization. In some implementations, the graph is a polygonal graph illustrating the normalized consumer data with respect to one or both of the performance of the market and performances of the one or more competitors of the organization. In some implementations, the graph is a consolidated scorecard displaying the normalized consumer data with respect to one or both of the performance of the market and a performance of the one or more competitors of the organization. In some implementations, the normalized consumer data is first normalized consumer data, and the computer-implemented method further includes receiving second normalized consumer data including consumer importance ratings and consumer satisfaction ratings of the capability of the organization.

In some implementations, the graph is a barometric graph illustrating the first normalized consumer data with respect to the second normalized consumer data and with respect to one or both of the performance the market and performances of the one or more competitors of the organization. In some implementations, the raw consumer data is first raw consumer data, and the computer-implemented method further includes receiving second raw consumer data including consumer importance ratings.

In some implementations, the graph is a scatter plot illustrating the first raw consumer data with respect to the second raw consumer data and with respect to the performance the market. In some implementations, the graph informs one of four organizational decisions including growing the capability, improving the capability, prolonging an improvement of the capability, and maintaining a performance level of the capability. In some implementations, the second raw consumer data further includes consumer satisfaction ratings.

In some implementations, the graph is a first graph, and the computer-implemented method further includes generating a second graph that is a bar graph illustrating the consumer importance ratings with respect to the consumer satisfaction ratings. In some implementations, the second raw consumer data further includes organizational importance ratings. In some implementations, the graph is a first graph, and the computer-implemented method further includes generating a second graph that is a bar graph illustrating the consumer importance ratings with respect to the organizational importance ratings.

In accordance with implementations of the present disclosure, techniques employed to assess capabilities of an organization can generate one or more graphical outputs that provide easy to understand, illustrated assessments of the capabilities of the organization with respect to an overall market capability based on multi-faceted consumer insights. Such graphical outputs can provide rapid insights into and assessments of a market, in depth insights into consumer priorities and expectations, competitive intelligence across multiple consumer capabilities, and actionable recommendations that may inform marketing, strategies, technology investments, and service investments of the organization. Furthermore, implementations of the present disclosure are flexible enough to assess different types of capabilities and may be relevant to a wide variety of industries.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example computing system that can execute implementations of the present disclosure.

FIG. 2 depicts an example capability assessment tool in accordance with implementations of the present disclosure.

FIG. 3 depicts an example capability scorecard in accordance with implementations of the present disclosure.

FIG. 4 depicts an example barometric graph in accordance with implementations of the present disclosure.

FIG. 5 depicts an example barometric graph in accordance with implementations of the present disclosure.

FIG. 6 depicts an example polygonal graph in accordance with implementations of the present disclosure.

FIG. 7 depicts an example consolidated scorecard in accordance with implementations of the present disclosure.

FIG. 8 depicts an example scatter plot in accordance with implementations of the present disclosure.

FIG. 9 depicts an example bar graph in accordance with implementations of the present disclosure.

FIG. 10 depicts an example bar graph in accordance with implementations of the present disclosure.

FIG. 11 depicts an example process that can be executed in implementations of the present disclosure.

FIG. 12 depicts an example computing system that can execute implementations of the present disclosure.

### DETAILED DESCRIPTION

Implementations of the present disclosure are generally directed to a computer-implemented framework for processing data related to capabilities of multiple entities (e.g., organizations) in order to effect changes in the capabilities of one of the multiple entities. For example, data of a first format (e.g., a raw format) can be processed to generate transformation data (e.g., conversion data) of a second format (e.g. a normalized format), such that the capabilities of the multiple entities can be compared or otherwise examined according to a normalized evaluation scheme based on the transformation data of the second format. Based on results produced by the normalized evaluation scheme, implementations of the present disclosure can generate outputs (e.g., graphs and displays) that provide assessments of the capabilities of one or more of the multiple entities. Such assessments can be used to effect a process change (e.g., improvement of a capability) associated with one of the multiple entities to achieve a desired result (e.g., improving customer satisfaction associated with a capability).

More particularly, implementations of the present disclosure are directed to a capability assessment tool (e.g., a tool that assesses one or more capabilities of an organization). In some examples, the capability assessment tool generates and provides one or more normalized graphical outputs based on raw input data. In some implementations, the capability assessment tool stores subjective data reflecting one or more of a consumer perspective of an organization, a consumer perspective of competitors of the organization, and an organizational perspective of consumer expectations. In some implementations, the capability assessment tool stores quantitative consumer data related to the organization, quantitative consumer data related to the competitors of the organization, and quantitative organizational data related to consumer expectations.

In some implementations, the capability assessment tool normalizes the raw consumer data and generates the graphical outputs from the normalized data. For example, the capability assessment tool can generate one or more of a barometer graph, a polygonal graph, a scatter plot, and a bar graph to provide easy to understand, illustrated assessments of the capabilities of the organization with respect to overall market capabilities based on multi-faceted consumer insights. In some examples, such graphical outputs provide rapid insights into and assessments of a local market, in depth insights into consumer priorities and expectations, competitive intelligence across multiple consumer capabilities of the organization, and actionable recommendations that may inform marketing, strategies, technology investments, and service investments of the organization. In contrast, many conventional consumer analysis methodologies limit outputs to qualitative (e.g., non-normalized) assessments or to excessively large, quantitative data sets that may be difficult to interpret or to understand within a short period of time.

Implementations of the present disclosure are described herein in a non-limiting, example context that includes the healthcare industry. Implementations of the present disclosure are described in further detail herein with reference to an example capability assessment tool with respect to the example context. It is appreciated, however, that implementations of the present disclosure are applicable in other contexts. For example, implementations of the present disclosure may also be used to assess capabilities of organizations in other, non-healthcare industries, such as other services industries, the automotive industry, the agricultural industry, the telecommunications industry, the retail industry, the financial industry, the pharmaceutical industry, and governmental agencies. That is, implementations of the present disclosure are flexible enough to be used for multiple applications and can be used across a wide variety of industries.

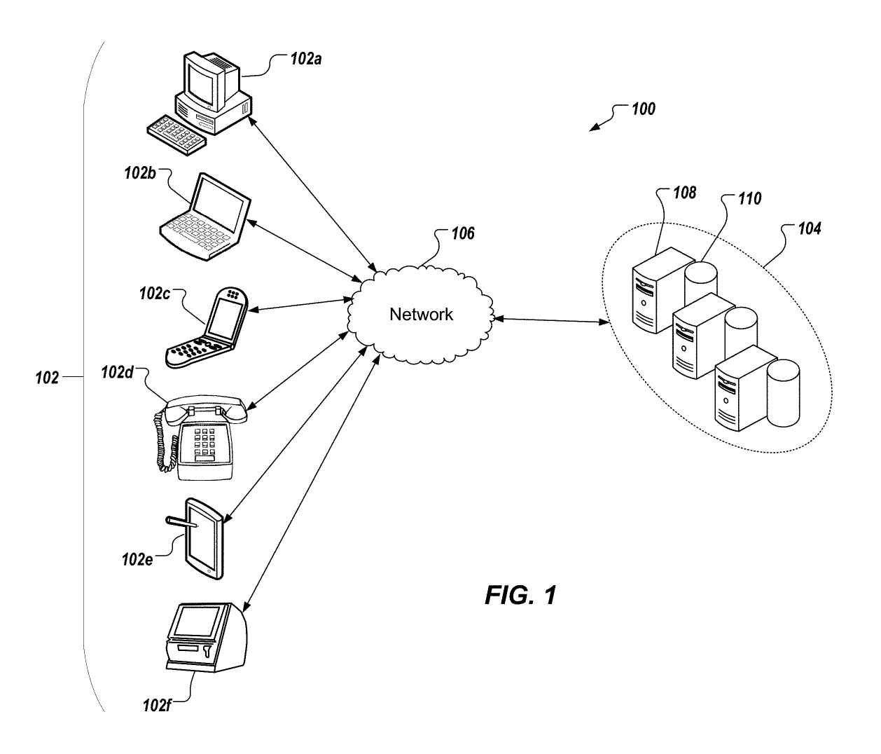

FIG. 1 depicts an example computing system 100 that can execute implementations of the present disclosure. The computing system 100 includes one or more computing devices 102 (e.g., client devices) that communicate with a server system 104 over a network 106. In the example of FIG. 1, the computing devices 102 include a desktop computer 102a, a laptop computer 102b, a mobile smart phone 102c, a landline phone 102d, a tablet computer 102e, and a kiosk computer 102f. In some implementations, any of the computing devices 102 may represent various forms of data processing devices including, but not limited to, a desktop computer, a laptop computer, a tablet computer, a handheld computer, a personal digital assistant (PDA), a cellular telephone, a network appliance, a camera, a smart phone, an enhanced general packet radio service (EGPRS) mobile phone, a media player, a navigation device, an email device, a game console, a kiosk computer, or a combination of any two or more of these data processing devices or other data processing devices. While six computing devices 102 are depicted in FIG. 1, it should be understood that the computing system 100 may include a different number of computing devices 102 in other implementations. The computing devices 102 can interact with application software provided by the server system 104.

Generally, the server system 104 includes one or more computers in one or more physical locations. In some implementations, the server system 104 includes one or more servers 108 and one or more databases 110 (e.g., repository resources). The servers 108 may represent various forms of servers including, but not limited to a web server, an application server, a proxy server, a network server, or a server farm. For example, the servers 108 may be application servers that execute software accessed by the computing devices 102. In operation, multiple computing devices 102 can communicate with the servers 108 via the network 106. While three servers 108 and three databases 110 are depicted in FIG. 1, it should be understood that the computing system 100 may, in some implementations, include a different number of servers 108 and a different number of databases 110. In some implementations, a user can invoke applications available on the servers 108 through a user-interface application (e.g., a web browser) running on a computing device 102. Each application can individually access data from one or more of the databases 110.

In some implementations, the computing system 100 can be a distributed client/server system that spans one or more networks that may include the network 106. The network 106 can be a large computer network, such as a local area network (LAN), wide area network (WAN), the Internet, a cellular network, or a combination thereof connecting any number of mobile clients, fixed clients, and servers. In some implementations, each computing device 102 can communicate with the server system 104 through a virtual private network (VPN), Secure Shell (SSH) tunnel, or other secure network connection. In some implementations, the network 106 can include the Internet, a wireless service network, and may include the Public Switched Telephone Network (PSTN). In other implementations, the network 106 may include a corporate network (e.g., an intranet) and one or more wireless access points.

Within the non-limiting example context discussed herein, implementations of the present disclosure will be described with respect to an example tool that can assess one or more capabilities of a healthcare organization to meet demands of consumers. The healthcare organization may be a public hospital system, a private hospital system, a governmental healthcare agency, a private healthcare practice, a health insurance provider, a pharmacy benefits management company, a retail healthcare organization (e.g., a retail pharmacy), or a medical equipment company. The consumers may include customers, such as customers of the healthcare organization (e.g., patients or employer groups), health insurance plan members, or pharmacy customers or other individuals associated with the customers (e.g., family members of the customers). The capabilities of the healthcare organization include one or more of a personalization capability, an access capability, a transparency capability, a consumer power capability, a multi-channel capability, a disintermediation capability, and other capabilities. The capabilities of the healthcare organization can be assessed with respect to a market (e.g., a local market, a regional market, a national market, or a global market) including the healthcare organization and one or more competitors of the healthcare organization. In some examples, the capabilities of the healthcare organization can be assessed with respect to a subset of the market (e.g., a single competitor of the healthcare organization or fewer than all of the competitors of the healthcare organization).

In implementations of the present disclosure, the computing devices 102 of the computing system 100 can provide user interfaces that are configured to receive inputs from consumers and from users of a capability assessment tool. The inputs are sent over the network 106 to the server system 104, on which the capability assessment tool is implemented. The server system 104 can generate outputs (e.g., graphical outputs and textual outputs) based on the inputs and send the outputs over the network 106 to one or more of the computing devices 102. The computing devices 102 can display the outputs to the users of the capability assessment tool.

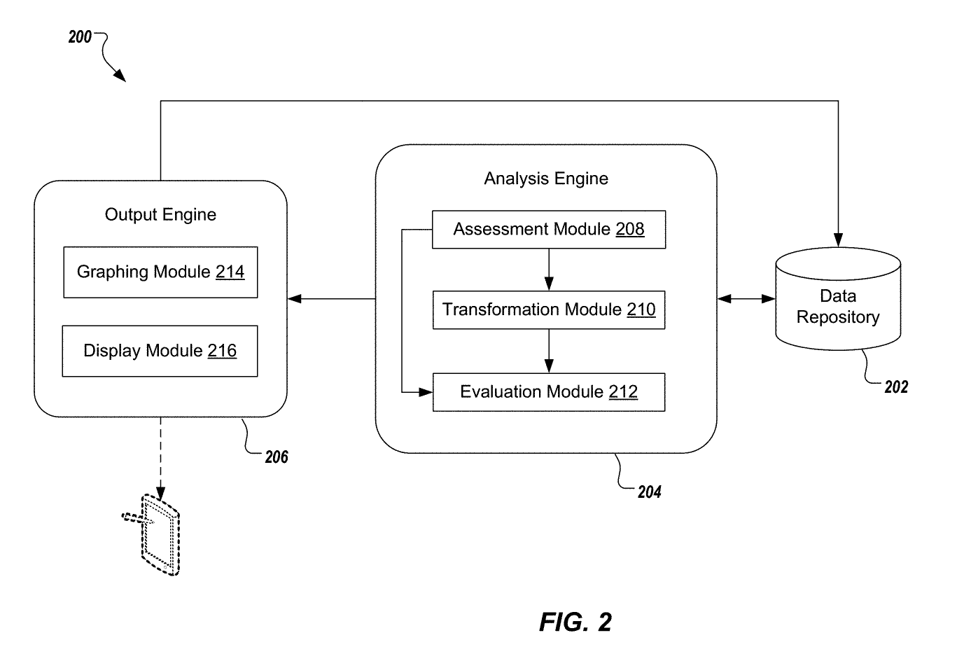

FIG. 2 depicts an example capability assessment tool 200 (e.g., a consumer capability assessment tool) in accordance with implementations of the present disclosure. In some examples, the capability assessment tool 200 is a computing environment implemented via the computing system 100. The capability assessment tool 200 includes a data repository 202 (e.g., implemented on one or more of the databases 110 of the computing system 100) that receives input data from a variety of sources over a network (e.g., the network 106 of the computing system 100). The capability assessment tool 200 also includes an analysis engine 204 (e.g., implemented on one or more of the servers 108 of the computing system 100) that retrieves the input data from the data repository 202. The capability assessment tool 200 further includes an output engine 206 (e.g., implemented on one or more of the servers 108 of the computing system 100) that receives processed data from the analysis engine 204, generates outputs based on the processed data, and sends the outputs to one or more computing devices (e.g., any of the computing devices 102 of the computing system 100).

The input data within the data repository 202 reflects a state of a market that includes multiple healthcare organizations (e.g., a reference healthcare organization and one or more competitors of the reference healthcare organization). The input data can include consumer data and organizational data. The consumer data can include consumer experience data and consumer opinion data related to the reference healthcare organization and related to one or more competitors of the healthcare organization. The consumer data can also include operational data (e.g., related to the reference healthcare organization and related to one or more competitors of the healthcare organization) that can affect consumer experiences. The organizational data can include data reflecting opinions, viewpoints, or perspectives of members of the reference healthcare organization about consumers of the market. In some examples, the input data may include competitor data that reflects opinions, viewpoints, or perspectives of members of one or more competitors of the reference healthcare organization about consumers of the market.

The input data can include one or both of raw data (e.g., data that has not been normalized or substantively modified prior to storage in the data repository 202) and modified data (e.g., data that has been normalized or otherwise modified with respect to its raw form). The input data may be subjective and qualitative (e.g., a consumer satisfaction rating provided as a verbal description, such as ‘Highly Satisfied’), subjective and quantitative (e.g., a consumer importance rating provided as a numerical rating, such as ‘55% Important’), objective and qualitative (e.g., an existence or a lack of a system feature, such as an ability to save family history information) or objective and quantitative (e.g., call wait times experienced by consumers).

In some implementations, the input data can include additional data associated with either or both of the consumers and one or more of the multiple organizations within the market. Such information can include demographic data, geographic data, economic data, infrastructure data (e.g., transportation data), and other types of data. For example, the additional data can include several demographic parameters (e.g., objective information) associated with the consumers, such as an age range, a gender, an ethnic origin, an educational level, a marital status, a parental status, an income level, a residential address (e.g., a zip code), an employment status, and a field of employment. In some implementations, the analysis engine 204 may retrieve a subset of the input data based on one or more specific demographic parameters or other information associated with one or both of the consumers and the market such that any analyses performed on the input data reflect only the subset of data.

In some examples, the consumer data reflects customer insights (e.g., subjective information, such as consumer opinions) gathered from one or more data collection mechanisms including site visits, operational data, executive communications, feedback forms, customer simulations, and primary customer research. In some examples, customer insights gathered from the site visits reflect in-person customer simulations (e.g., interactions for attempting to schedule care, for navigating to a location, for pharmacy questions, or for waiting times to have a health question answered) performed at one or both the healthcare organization and one or more competitors of the healthcare organization. Such customer insights may also reflect interviews conducted with front-line staff, concierge personnel, and medical professionals of one or both of the healthcare organization and one or more competitors of the healthcare organization. In some examples, customer insights gathered from operational data reflect call center data, hospital profile data, hospital payer mix data, and patient segmentation profile data from one or both of the healthcare organization and one or more competitors of the healthcare organization.

In some examples, customer insights gathered from executive communications reflect responses provided during interviews of executives and board of director members of the healthcare organization. Such customer insights may also reflect survey responses received from executives and board of director members of the healthcare organization that are related to consumerism expectations and insights. In some examples, customer insights gathered from feedback forms reflect feedback provided from customers of one or both of the healthcare organization and one or more competitors of the healthcare organization in web surveys and third party customer reviews. In some examples, customer insights gathered from customer simulations reflect secret shopper calls to one or both of the healthcare organization and one or more competitors of the healthcare organization.

In some examples, customer insights gathered from customer interactions reflect one or more of website interactions mobile interactions, and portal interactions of various systems of one or both of the healthcare organization and one or more competitors of the healthcare organization. Accordingly, data is collected via organizational systems, tools, and channels. For example, customer access metrics (e.g., call times, wait times, number of transfers, phone trees, and customer experiences) may be gathered for calls made to call centers. In some examples, customer insights gathered from primary customer research reflect data collected directly from the customers of the healthcare organization (who may also be customers of one or more competitors of the healthcare organization). Such customer insights may also reflect one or more of consumerism market surveys, regular (e.g., quarterly or annual) customer surveys, national or global surveys, and patient engagement surveys provided to the customers of the healthcare organization.

In some implementations, the capability assessment tool 200 assesses the capabilities (e.g., a personalization capability, an access capability, a transparency capability, a consumer power capability, a multi-channel capability, and a disintermediation capability) of the reference healthcare organization and the one or more competitors of the reference healthcare organization using the input data within the data repository 202 gathered from any of the above-described data collection mechanisms. Each capability may include multiple sub-capabilities that reflect one or more key performance indicators (KPIs) of the healthcare organization. The KPIs may be subjective or objective and qualitative or quantitative, as discussed above with respect to the input data.

In some examples, personalization refers to the capability of the healthcare organization to provide consumers with customized care or targeted care and services based on unique needs of the consumers, based on preferences of the consumers, and based on past (e.g., historical) interactions between the consumers and the healthcare organization. The personalization capability of the healthcare organization may include one or more sub-capabilities of interaction management, patient portal customization, and personalized outreach.

In some examples, interaction management refers to an organizational system feature for saving consumer information (e.g., patient information) received in the organizational system within a defined period of time. In some examples, interaction management refers to an organizational system feature for tracking communications (e.g., messages, phone calls, and physical mail) between the healthcare organization and the consumers throughout a defined period of time. In some examples, interaction management refers to an organizational system feature for cross-channel coordination, which measures the ability of an organization to track and manage user information across multiple channels so consumers do not need to repeat information across call transfers and system applications. In some examples, interaction management refers to a variable or a parameter associated with a level of consumer satisfaction with an ability of the healthcare organization to seamlessly access electronic medical records (EMRs).

In some examples, patient portal customization refers to one or more of an organizational system feature for presenting a personalized introductory test to patients, an organizational system feature for saving patient healthcare information (e.g., one or more diagnoses or a family history), an organizational system feature for providing customized information (e.g., forums and articles) to patients, and an organizational system feature for providing user-friendly system tools to patients. In some examples, patient portal customization refers to a consumer satisfaction with an overall personalization capability of the healthcare organization.

In some examples, personalized outreach refers to an organizational system feature for sending out personalized wellness notifications based on a name, a family history, or a patient's interests. In some examples, personalized outreach refers to an organizational system feature for sending tailored outreach messages based on a diagnosis or preventive measures. In some examples, personalized outreach refers to a consumer satisfaction with personalized notifications sent out by the healthcare organization.

In some examples, access refers to the capability of the healthcare organization to enable consumers to schedule appointments with physicians preferred by the consumers and at times and locations preferred by the consumers. The access capability of the healthcare organization may include one or more sub-capabilities of first available appointments, call resolution, and caller experience. Service options associated with such aspects of appointment scheduling may include one or more of an online referral system, a phone referral system, a centralized scheduling option, a department scheduling option, an online request, an online chat session, an on-call nurse, and an online scheduling option.

In some examples, transparency refers to a capability of the healthcare organization to provide consumers with clear, actionable information (e.g., cost information, quality information, medical information, and patient reviews) for assisting consumers in making informed decisions regarding selection of potential healthcare services and potential healthcare providers. The transparency capability of the healthcare organization may include one or more sub-capabilities associated with provider reviews, cost tools, and outcomes and quality.

The provider reviews may include one or more of general system reviews (e.g., hospital reviews and facility reviews), primary care physician and services reviews, specialty care physician and services reviews. In some examples, the provider reviews reflect an ease of locating healthcare service providers. In some examples, the provider reviews reflect a usability (e.g., a user-friendliness) of healthcare provider systems. In some examples, the provider reviews reflect a consumer satisfaction with organizational system offerings for physician reviews and hospital reviews.

In some examples, the cost tools include offerings for one or more of primary care cost information, specialty care cost information, medical procedure cost information, facility cost information, and screening information. In some examples, the cost tools reflect one or both of an ease of locating cost information and an overall usability of a provider system with respect to an in-depth consumer understanding of healthcare costs. In some examples, the sub-capability of outcomes and quality reflects general outcome data (e.g., related to readmissions and other outcome parameters) related to one or more of a hospital system or a facility, primary care outcomes, specialty care outcomes, and procedure outcomes. In some examples, the sub-capability of outcomes and quality reflects one or both of an ease of locating outcome information and a usability (e.g., a user-friendliness) of outcome data. In some examples, the sub-capability of outcomes and quality reflects a consumer satisfaction with an availability of quality and outcome ratings.

In some examples, consumer power refers to a capability of the healthcare organization to provide consumers with options for achieving desired tasks through self-service. The consumer power capability of the healthcare organization may include one or more sub-capabilities of appointment self-scheduling, electronic prescription refills, proactive notifications, and bill pay. In some examples, appointment self-scheduling reflects one or more of an organizational system feature for scheduling appointments with primary care physicians, an organizational system feature for scheduling appointments with specialists, an organizational system feature for scheduling medical procedures (e.g., CT scans, Mills, or ultrasounds), and an organizational system feature for rescheduling or cancelling appointments, an organizational system feature for viewing appointment histories and scheduled, future appointments. In some examples, appointment self-scheduling reflects a usability of self-scheduling tools.

In some examples, electronic prescription refills refers to one or more of an organizational system feature for requesting a prescription renewal, an organizational system feature for requesting electronic refills, an organizational system feature for requesting after-hours prescription pickup. In some examples, electronic prescription refills refers to a usability of electronic prescription refill tools. In some examples, proactive notifications include appointment reminders and appointment confirmations via phone call, text, or email, and preventive care reminders. In some examples, bill pay includes one or more of an online payment feature, an organizational system feature for viewing a payment history, an organizational system feature for checking existing balances, an organizational system feature for automatic bill payment, and an organizational system feature for enabling payment plans online. In some examples, bill pay sub-capability reflects a usability of bill pay tools.

In some examples, multi-channel refers to a capability of the healthcare organization to allow consumers to interact with the healthcare organization and access information through one or more channels preferred by the consumers. The multi-channel capability of the healthcare organization may include one or more sub-capabilities of online access, phone access, mobile access, and in-person access.

In some examples, online access reflects a consumer satisfaction with online tools provided by the healthcare organization. In some examples, online access includes a website providing consumer power capabilities (e.g., scheduling, bill pay, and electronic refills). In some examples, online access reflects a usability of such a website. In some examples, online access includes an organizational system feature for online chatting. In some examples, online access includes social media access to the healthcare organization. In some examples, phone access reflects a consumer satisfaction with phone tools provided by the healthcare organization, a phone experience, a phone system providing consumer power capabilities, call wait times, and a feature for transferring a call to an appropriate personnel member. In some examples, mobile access reflects a consumer satisfaction with mobile tools provided by the healthcare organization. In some examples, mobile access includes a mobile site providing consumer power capabilities and may reflect a usability of such a mobile site. In some examples, mobile access includes a mobile application providing consumer power capabilities and may reflect a usability of such a mobile application.

In some examples, disintermediation refers to a capability of the healthcare organization to adapt to emerging competitors and emerging digital solutions that transform manners in which consumers seek medical care. Example emerging digital solutions include hospital-agnostic tools that allow patients to schedule appointments at their convenience, transparency tools that allow consumers to shop for low cost, high quality healthcare procedures nationwide, and bill pay tools that allow patients to securely pay, manage, and track healthcare expenses online. Other emerging digital solutions include healthcare tools that allow consumers to track caloric intake and exercise parameters and virtual analytic tools that determine whether a patient is experiencing health problems or that provide access to screening tools and health risk assessments.

In some examples, the disintermediation capability of the healthcare organization includes one or more sub-capabilities associated with retail clinic partnerships and innovation funding. In some examples, retail clinic partnerships reflects one or more of a geographic locational spread of retail clinics with which the healthcare organization partners, and duration of time that the healthcare organization has been in partnership with retail clinics, a consumer satisfaction of the retail partnerships offered by the healthcare organization, and a local market size for retail health clinics. In some examples, innovation funding includes amounts funded by the healthcare organization towards various emerging digital solutions.

Referring again to FIG. 2, the analysis engine 204 includes an assessment module 208, a transformation module 210, and an evaluation module 212. The assessment module 208 determines whether input data retrieved from the data repository 202 is of a raw format (e.g., a non-normalized format) that cannot be examined according to a normalized evaluation scheme or whether input data retrieved from the data repository 202 is of a normalized format (e.g., a numerically rated, quantitative format) that can be examined according to a normalized, quantitative evaluation scheme. If the input data is of the normalized format, then the assessment module 208 sends the input data to the evaluation module 210, which can further process the input data.

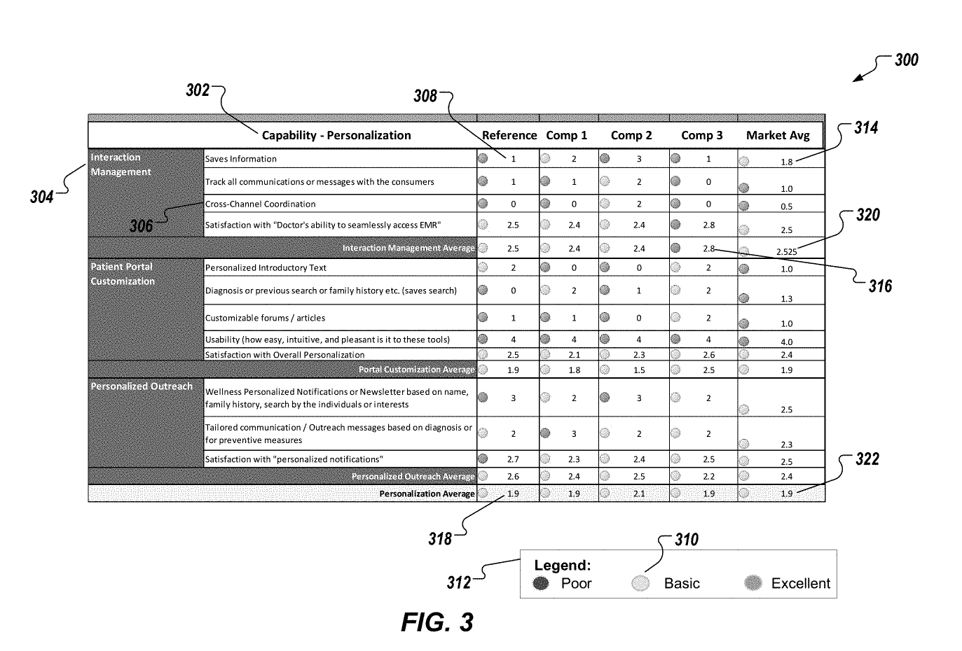

In some examples, if the input data is of the raw format, then the assessment module 208 sends the input data to the transformation module 210, which can process the input data to generate normalized data associated with the input data of the raw format. Accordingly, the normalized data generated by the transformation module 210 is transformation data (e.g., conversion data) associated with input data of the raw format. For example, as discussed in more detail below with respect to FIG. 3, the normalized data generated by the transformation module 210 can be provided as numerical ratings (e.g., normalization factors) associated with input data of the raw format, such that the normalized data can be examined according to a normalized, quantitative evaluation scheme. The transformation module 210 sends the normalized data to the evaluation module 212, which can further process the normalized data.

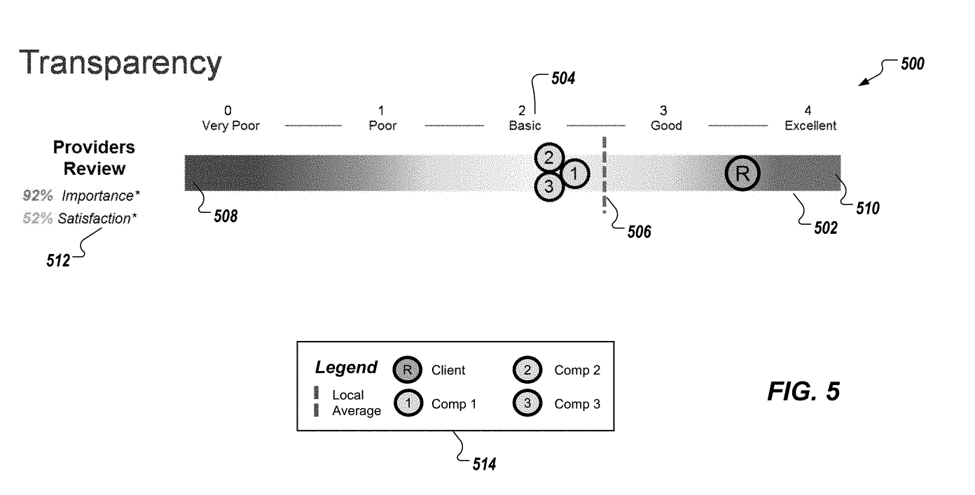

In some examples, the evaluation module 212 generates a data structure (e.g., a scorecard) that stores input data of the normalized format received from the assessment module 208 and normalized data received from the transformation module 210. The evaluation module 212 evaluates the data (e.g., provided as numerical ratings) to generate multiple scores (e.g., computed ratings) that are also stored in the data structure. The evaluation module 212 can send the data structure to the output engine 206, which can generate one or more outputs based on the data and the scores stored in the data structure, such as the outputs shown in FIGS. 5-8. The evaluation module 212 can also send the data structure to the data repository 202 to be stored in the data repository 202.

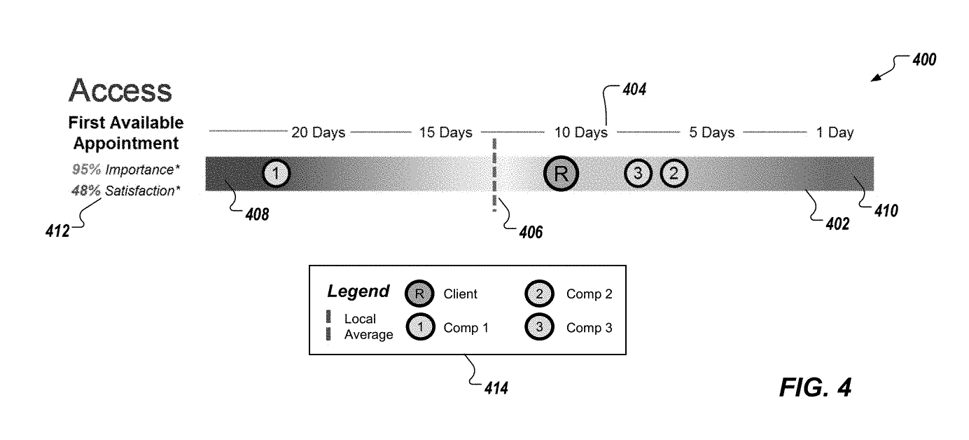

In some examples, if the input data is of the raw format, then the assessment module 208 may send the input data directly to the evaluation module 212. For example, the assessment module 208 may send quantitative raw data (e.g., measured parameters, consumer satisfaction ratings, consumer importance ratings, organizational importance ratings, and other quantitative raw data) directly to the evaluation module 212, which can further process the data to generate computed averages of the data. The evaluation module 212 can send the computed averages to the output engine 206, which can generate one or more outputs based on the computed averages, such as the outputs shown in FIGS. 4, 9, and 10. The evaluation module 212 can also send the computed averages to the data repository 202 to be stored in the data repository 202.

The output engine 206 includes a graphing module 214 and a display module 216. As will be discussed in more detail below with respect to FIGS. 4-6 and 8-10, the graphing module 214 can plot data in a variety of coordinate systems to generate barometric graphs, polygonal graphs, scatter plots, bar graphs, and other types of graphs. The display module 216 can generate graphical displays (e.g., consolidated scorecards) that summarize data associated with one or more of the outputs generated by the graphing module 214.

FIG. 3 depicts an example capability scorecard 300 in accordance with implementations of the present disclosure. The capability scorecard 300 is a data structure that is generated by the evaluation module 212 of the analysis engine 204 of the capability assessment tool 200 based on input data received from the assessment module 208 of the analysis engine 204. The capability scorecard 300 is associated with a capability 302 (e.g., the personalization capability in the example of FIG. 3) of a reference healthcare organization and of multiple competitors of the reference healthcare organization. The capability 302 includes multiple sub-capabilities 304 that each reflect multiple KPIs 306.

In some examples (e.g., when the assessment module 208 determines that the KPIs 306 are provided in a raw, non-normalized data format), the KPIs 306 are rated numerically by the transformation module 210 of the analysis engine 204. In some examples, the KPIs 306 are rated numerically by a user (e.g., an employee or a consultant of the reference healthcare organization or another individual affiliated with the reference healthcare organization) of the capability assessment tool 200 based on input data of the raw format stored in the data repository 202. In some examples, the KPIs 306 are rated numerically by the user of the capability assessment tool 200 based on consumer data that has not been stored in the data repository 202. In some examples, the KPIs 306 are rated numerically, directly by consumers as a part of one or more of the above-described data collection mechanisms. Whether generated by the transformation module 210, provided by users of the capability assessment tool 200, or provided by consumers, KPI ratings 308 of the KPIs 306 are stored in the capability scorecard 300 as normalized data. In some examples, the evaluation module 210 sends the capability scorecard 300 to the data repository 202, which stores the capability scorecard 300 in association with raw consumer data related to the KPIs 306.

In some examples, the KPI ratings 308 are entered in an electronic form provided in a user interface at a client device (e.g., a computing device 102 of the computing system 100) connected to the data repository 202 over a network (e.g., the network 106 of the computing system 100). In some examples, the KPI ratings 308 are written on a physical form that is converted into an electronic document (e.g., a scanned document or a photo) that is readable by the system (e.g., the computing system 100) on which the capability assessment tool 200 is implemented and stored in the data repository 202.

In an example rating scheme, the KPI ratings 308 are provided as integer ratings including the numbers 0 through 4 for the reference healthcare organization (denoted as ‘Reference’ in the example of FIG. 3) and for the competitors of the reference healthcare organization (denoted as ‘Competitor 1,’ ‘Competitor 2,’ and ‘Competitor 3’ in the example of FIG. 3). Each integer rating may be associated with a color code 310 provided in a legend 312. In the example rating scheme, the KPI ratings 308 correspond to qualitative descriptions of ‘Very Poor’ (corresponding to an integer rating of 0 and a color of red), ‘Poor’ (corresponding to an integer rating of 1 and a color of red), ‘Basic’ (corresponding to an integer rating of 2 and a color of yellow), ‘Good’ (corresponding to an integer rating of 3 and a color of green), and ‘Excellent’ (corresponding to an integer rating of 4 and a color of green).

In other examples, the qualitative descriptions of the rating scheme may correspond to numerical buckets based on measured, quantitative data. For example, for an example KPI of ‘call wait times’ (associated with the sub-capability of ‘phone’ and the capability of ‘multi-channel’), the KPI ratings 308 may correspond to qualitative descriptions of ‘Very Poor’ (corresponding to an integer rating of 0, a call wait period of 120+ seconds, and a color of red), ‘Poor’ (corresponding to an integer rating of 1, a call wait period 90-119 seconds, and a color of red), ‘Basic’ (corresponding to an integer rating of 2, a call wait period of 60-89 seconds, and a color of yellow), ‘Good’ (corresponding to an integer rating of 3, a call wait period of 30-59 seconds, and a color of green), and ‘Excellent’ (corresponding to an integer rating of 4, a call wait period of 0-29 seconds, and a color of green). In some implementations, the KPI ratings 308 are provided as integer ratings on a different scale or as non-integer ratings (e.g., percentage ratings or ratings with significant digits). In some implementations, the KPI ratings 308 are associated with a shape code (e.g., circles, squares, triangles, etc.) or other code instead of or in addition to the color code 310.

Once the evaluation module 212 receives the KPI ratings 308 from the assessment module 208 or from the transformation module 210, then the evaluation module 212 can generate multiple computed ratings based on the KPI ratings 308. For example, the evaluation module 212 can compute a market (e.g., average) KPI rating 314 across the reference healthcare organization and the competitors of the reference healthcare organization. The evaluation module 212 can also compute an organizational sub-capability rating 316 (e.g., as an average of the KPI ratings 308 for a particular sub-capability) for the reference healthcare organization and for each competitor of the reference healthcare organization. The evaluation module 212 can also compute an organizational capability rating 318 (e.g., as an average of all of the KPI ratings 308 associated with the capability 302) for the reference healthcare organization and for each competitor of the healthcare organization. The evaluation module 212 204 can also compute a market sub-capability rating 320 (e.g., as an average of all of the organizational sub-capability ratings 316) and a market capability rating 322 (e.g., as an average of all of the organizational capability ratings 318) across the reference healthcare organization and the competitors of the healthcare organization. In the example of FIG. 3, Competitor 3 leads the market with respect to the sub-capabilities 304 of interaction management and portal customization, while the reference healthcare organization leads the market with respect to the sub-capability 304 of personalized outreach. Competitor 2 leads the market with respect to the capability 302 (e.g., the overall capability) of personalization.

As discussed above with respect to FIG. 2, input data of the raw format within the data repository 202 can include consumer importance ratings (e.g., reflecting how important a feature is to consumers) and consumer satisfaction ratings (e.g., reflecting how satisfied consumers are with a feature) regarding various capabilities 302, sub-capabilities 304, and KPIs 306 associated with the reference healthcare organization. For example, consumers may rate the feature of ‘appointment availability’ as having an importance of 90% out of 100% (e.g., on a percentage scale), but may indicate that they are only 50% out of 100% satisfied with this feature. In some examples, consumer importance ratings and consumer satisfaction ratings may be provided on a different scale (e.g., an integer scale). In some examples, the input data may include organizational importance ratings (e.g., reflecting how important a feature is to consumers from the perspective of executives and board of director members of the reference healthcare organization). Accordingly, priorities of the reference healthcare organization may be compared to priorities of the consumers.

In some implementations, the evaluation module 212 of the analysis engine 204 receives the consumer importance ratings, the consumer satisfaction ratings, and the organizational importance ratings from the assessment module 210 of the analysis engine 204. The evaluation module 212 can process the ratings to compute an average consumer importance rating, an average consumer satisfaction rating, and an average organizational importance rating for each capability 302 and sub-capability 304 of the reference healthcare organization and for each KPI 306 associated with the reference healthcare organization. In some examples, the evaluation module 212 processes the ratings to compute an average consumer importance rating and an average consumer satisfaction rating for each capability 302 and sub-capability 304 of the competitors of the reference healthcare organization and for each KPI 306 associated with the competitors of the reference healthcare organization.

Input data of the raw format can also include measured (e.g., quantitative) parameters associated with one or more of the sub-capabilities 304 or the KPIs 306, such as a number of days that a patient must wait until a first medical appointment is available with the reference healthcare organization, or a number of retail clinics that are partnered with the reference healthcare organization. In some examples, the evaluation module 212 of the analysis engine 204 receives the measured parameters from the assessment module 208 and processes the measured parameters to compute average parameters for the reference healthcare organization, average parameters for each of the competitors of the reference healthcare organization, and an average market parameter across the reference healthcare organization and the competitors of the reference healthcare organization.

In some implementations, the evaluation module 212 of the analysis engine 204 sends processed data including one or more of the average parameters, the average consumer importance ratings, the average consumer satisfaction ratings, the average organizational importance ratings, and the capability scorecard 300 to the output engine 206. In some examples, either or both of the graphing module 214 and the display module 216 of the output engine 206 generate one or more graphical outputs based on the processed data and sends the one or more graphical outputs to a computing device over a network (e.g., to a computing device 102 over the network 106 of the computing system 100) for display to a user of the capability assessment tool 200. In some examples, the output engine 206 sends one or more graphical outputs to the data repository 202 for storage of the one or more graphical outputs, which may be accessed in future instances.

In some implementations, the capability assessment tool 200 maintains relationships among the graphical outputs. For example, the capability assessment tool 200 can maintain a hierarchical relationship between two or more graphical outputs to allow a user to intuitively move between general graphical outputs to more detailed graphical outputs. Hierarchically related graphical outputs can be of the same type or may be of different types, depending on a user preference.

FIG. 4 depicts an example barometric graph 400 in accordance with implementations of the present disclosure. The barometric graph 400 provides a consumer capability performance barometer that is generated by the graphing module 214 of the output engine 206 and that summarizes performances of the reference healthcare organization and the competitors of the reference healthcare organization with respect to a particular, sub-capability 304 (e.g., ‘first available appointment’ of the capability ‘access’ in the example of FIG. 4) using measured data (e.g., quantitative raw data) processed by the evaluation module 212 of the analysis engine 204. Accordingly, the barometric graph 400 provides insight into the performances at one level down from the overall capability 302. The barometric graph 400 includes a performance bar 402 along which each organization is plotted, a scale 404 indicating units of measure (e.g., days in the example of FIG. 4), and a base line 406 denoting an average market value of the parameter.

In some examples, the performance bar 402 has a color coding (e.g., a hue or a shading) that corresponds to a level of performance as reflected by the measured units provided in the scale 404. For example, a first hue 408 (e.g., a color of red) of the performance bar 402 is deepest at an extreme left end of the performance bar 402 and corresponds to a lowest performance level of Very Poor (e.g., greater than 20 days). A second hue 410 of the performance bar 402 is deepest at an extreme right end of the performance bar 402 and corresponds to a highest performance level of Excellent (e.g., less than 1 day). The first hue 408 and the second hue 410 reach a neutral tone at the base line 406, which corresponds to a performance level of Basic or Average (e.g., approximately 14 days).

In some examples, the barometric graph 402 is accompanied by a display 412 providing additional information including an average consumer importance rating and an average consumer satisfaction rating collected from survey data and associated with the sub-capability 304 of ‘first available appointment.’ The barometric graph 402 may also include a legend 414 that illustrates markings for the base line 406, the reference healthcare organization (denoted by the letter ‘R’) and the competitors of the reference healthcare organization (denoted individually by the numbers ‘1,’ ‘2,’ and ‘3’). In the example of FIG. 4, the reference healthcare organization performs above a market average, above a first competitor that performs below the market average, and below second and third competitors that perform above the market average.

FIG. 5 depicts an example barometric graph 500 in accordance with implementations of the present disclosure. The barometric graph 500 provides a consumer capability performance barometer that is generated by the graphing module 214 of the output engine 206 and that summarizes performances of the reference healthcare organization and the competitors of the reference healthcare organization with respect to a particular, sub-capability 304 (e.g., ‘provider reviews’ of the capability ‘transparency’ in the example of FIG. 5) based on organizational sub-capability ratings 316 calculated by the evaluation module 212 of the analysis engine 204. Accordingly, the barometric graph 500 provides insight into the performances at one level down from the overall capability 302. The barometric graph 500 includes a performance bar 502 along which each organization is plotted, a scale 504 including integer ratings (e.g., 0-4) and qualitative descriptions (e.g., Very Poor-Poor-Basic-Good-Excellent), and a base line 506 denoting an average market value of the sub-capability 304.

In some examples, the performance bar 502 has a color coding (e.g., a hue or a shading) that corresponds to a level of performance as reflected by the measured units provided in the scale 504. For example, a first hue 508 (e.g., a color of red) of the performance bar 502 is deepest at an extreme left end of the performance bar 502 and corresponds to a lowest performance level of Very Poor (e.g., a rating of 0). A second hue 510 of the performance bar 502 is deepest at an extreme right end of the performance bar 502 and corresponds to a highest performance level of Excellent (e.g., a rating of 4). The first hue 508 and the second hue 510 reach a neutral tone at the base line 506, which corresponds to a performance level of Basic or Average (e.g., between ratings of 2 and 3).

In some examples, the barometric graph 502 is accompanied by a display 512 providing additional information including an average consumer importance rating and an average consumer satisfaction rating associated with the sub-capability 304 of ‘provider reviews.’ In this example, the average consumer satisfaction rating can be one of the KPI ratings 308 that are accounted for in the organizational sub-capability ratings 316. The barometric graph 502 may also include a legend 514 that illustrates markings for the base line 506, the reference healthcare organization (denoted by the letter ‘R’) and the competitors of the reference healthcare organization (denoted individually by the numbers ‘1,’ ‘2,’ and ‘3’). In the example of FIG. 5, the reference healthcare organization performs above a market average and above first, second, and third competitors that perform below the market average.

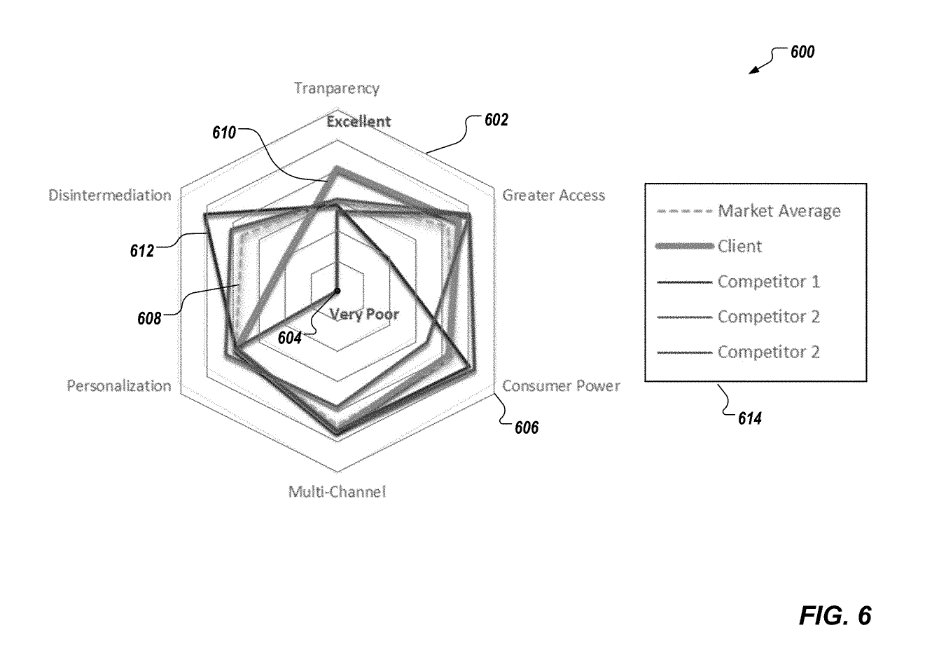

FIG. 6 depicts an example polygonal graph 600 in accordance with implementations of the present disclosure. The polygonal graph 600 provides an aggregated consumer capability profile that is generated by the graphing module 214 of the output engine 206 and that summarizes performances of the reference healthcare organization and the competitors of the reference healthcare organization with respect to the capabilities of personalization, access, transparency, consumer power, multi-channel, and disintermediation. The polygonal graph 600 includes a concentric scale 602 including multiple levels that correspond to the organizational sub-capability ratings 316 calculated by the analysis engine 204. An origin 604 of the concentric scale 602 corresponds to the rating of ‘Very Poor,’ while an outermost level of the concentric scale 602 corresponds to the rating of ‘Excellent.’ The example polygonal graph 600 includes multiple vertices 606 that respectively correspond to the capabilities 302 of the reference healthcare organization. Accordingly, the polygonal graph 600 is a hexagonal graph in the example of FIG. 6. In some implementations, the polygonal graph 600 may reflect a different number (e.g., n) of capabilities 302, thereby including a different number, i.e., n, of vertices 606 and taking the form of a n-gonal graph.

In some examples, the polygonal graph 600 includes a baseline plot 608 (e.g., indicated by a dashed line in the example of FIG. 6) reflecting an average market performance, an organizational plot 610 reflecting the performance of the reference healthcare organization, and multiple competitor plots 612 reflecting the performances of the competitors of the reference healthcare organization. While the example polygonal graph 600 illustrates three competitors of the reference healthcare organization, in some implementations, the polygonal graph 600 may illustrate a different number of competitors. In some examples, the polygonal graph 600 includes a legend 614 indicating line types of the various plots 608, 610, 612. As shown in the example of FIG. 6, the reference healthcare organization outperforms the market (e.g., the market average) with respect to transparency, access, and multi-channel. The reference healthcare organization underperforms the market with respect to consumer power and disintermediation and performs about equal to the market with respect to personalization. In some implementations, the polygonal graph 600 can additionally or alternatively include one or more plots reflecting a performance of the reference healthcare organization or a performance of one or more competitors of the healthcare organization with respect to one or more sub-capabilities. Such plots may provide more detailed insights into the performances of the organizations.

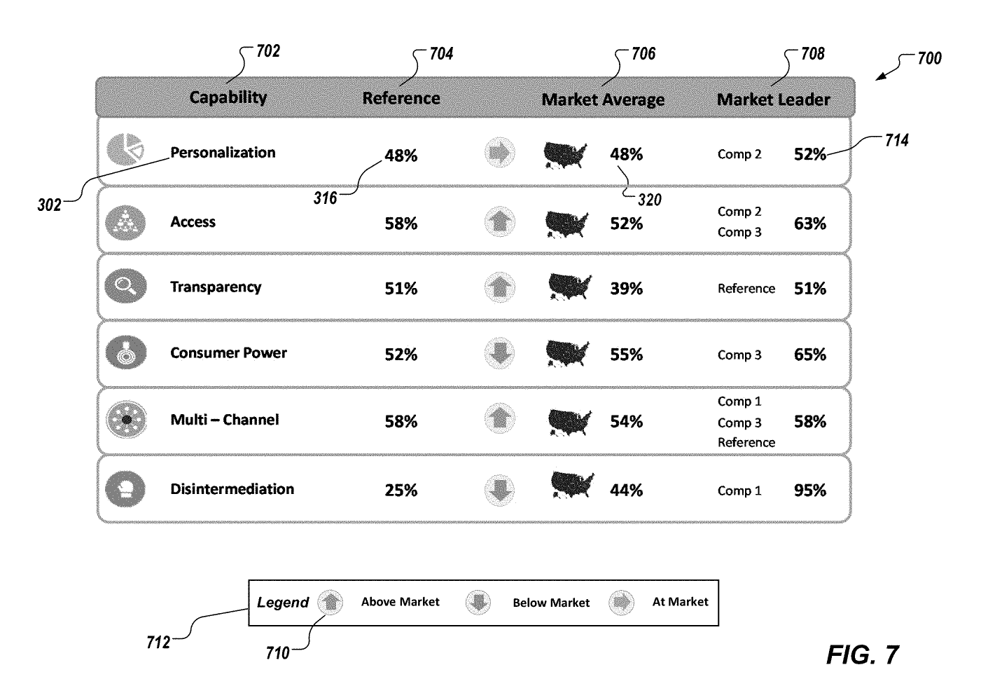

FIG. 7 depicts an example consolidated scorecard 700 in accordance with implementations of the present disclosure. The consolidated scorecard 700 is provided as a graphical, tabular display that is generated by the display module 216 of the output engine 206 and that summarizes performances (e.g., provided as the organizational capability ratings 318) of the reference healthcare organization and the competitors of the healthcare organization with respect to the capabilities 302 of personalization, access, transparency, consumer power, multi-channel, and disintermediation. The consolidated scorecard 700 includes column headings corresponding to capability 702, the reference healthcare organization 704, an average market performance 706, and a leading market performance 708. In some examples, the capabilities 302 are ranked in an order of consumer-rated importance levels. In the example of FIG. 7, the sub-capability ratings 304 are provided as percentages (e.g., as opposed to numerical integer ratings) and are presented with arrows 710 that indicate whether the reference healthcare organization performs above, below, or at market levels, as shown in a legend 712. A leading market performance rating 714 (e.g., reflecting a leading organizational capability rating 318) is shown along with an associated organization.

As shown in the example of FIG. 7, the reference healthcare organization outperforms the market (e.g., the market average) with respect to transparency, access, and multi-channel. The reference healthcare organization underperforms the market with respect to consumer power and disintermediation and performs about equal to the market with respect to personalization. In some implementations, the consolidated scorecard 700 may be outputted by the output engine 206 in association with the polygonal graph 600 for an aggregated or combined display of the consolidated scorecard 700 and the polygonal graph 600.

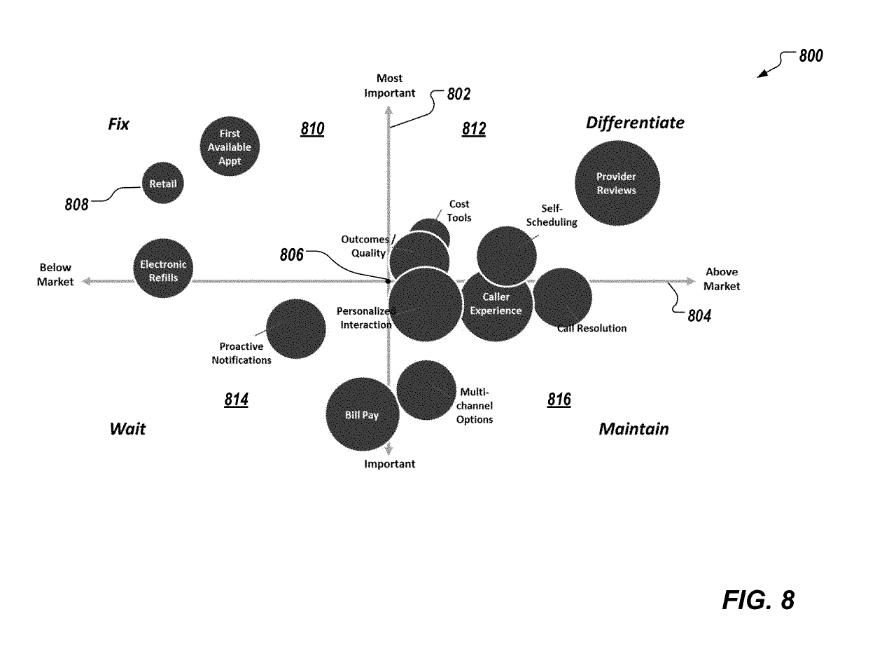

FIG. 8 depicts an example scatter plot 800 in accordance with implementations of the present disclosure. The scatter plot 800 (e.g., provided as a 2×2 matrix) provides a consumer capability investment matrix that is generated by the graphing module 214 of the output engine 206 and that summarizes performances of a healthcare organization (e.g., the reference healthcare organization or any of the competitors of the reference healthcare organization) with respect to several sub-capabilities 304 of the healthcare organization. The scatter plot 800 includes a first axis 802 (e.g., a vertical axis) indicating an average consumer importance rating and a second, orthogonal axis 804 (e.g., a horizontal axis) associated with a market performance. An origin 806 of the scatter plot 800 corresponds to a median value of a consumer importance rating scale. For example, the origin 806 corresponds to a consumer importance rating of 50% for a consumer importance that is rated on a scale of 0-100%. In some examples, the origin 806 may correspond to a relative median value of the consumer importance rating scale if a lowest consumer importance rating is taken as a starting point for the scale. For example, the origin 806 may correspond to a consumer importance rating of 70% for a consumer importance that is rated on a scale of 0-100%, but where the lowest consumer importance rating is 40%. The origin 806 of the scatter plot 800 also corresponds to the market sub-capability ratings 320 calculated by the analysis engine 204.

The sub-capabilities 304 are plotted on the scatter plot 800 as circles 808 having a size corresponding to their respective, organizational sub-capability ratings 316. In some examples, a vertical position of a circle 808 reflects an average consumer importance rating associated with the sub-capability 304 corresponding to the circle 808. In some examples, a horizontal position of a circle 808 reflects a difference between the organizational sub-capability rating 316 and the market sub-capability rating 320.

The first and second axes 802, 804 of the scatter plot 800 form four quadrants in which the circles 808 can be plotted. A first, upper left quadrant 810 of the scatter plot 800 indicates sub-capabilities 304 that are relatively important to consumers of the healthcare organization, but for which the healthcare organization underperforms the market (e.g., lags an average market performance). Accordingly, circles 808 falling in the first quadrant 810 indicate sub-capabilities 304 that should be fixed or improved by the healthcare organization. A second, upper right quadrant 812 of the scatter plot 800 indicates sub-capabilities 304 that are relatively important to the consumers of the healthcare organization, and for which the healthcare organization outperforms the market (e.g., beats the average market performance). Accordingly, circles 808 falling in the second quadrant 812 indicate sub-capabilities 304 which the healthcare organization may wish to further differentiate or grow in order to gain an even stronger position in the market and/or may wish to advertise to show its performance with respect to that of competitors.

A third, lower left quadrant 814 of the scatter plot 800 indicates sub-capabilities 304 that are relatively less important to the consumers of the healthcare organization, and for which the healthcare organization underperforms the market. Accordingly, circles 808 falling in the third quadrant 814 indicate sub-capabilities 304 for which the healthcare organization can prolong or wait to implement improvement actions. A fourth, lower right quadrant 816 of the scatter plot 800 indicates sub-capabilities 304 that are relatively less important to the consumers of the healthcare organization, and for which the healthcare organization outperforms the market. Accordingly, circles 808 falling in the fourth quadrant 816 indicate sub-capabilities 304 for which the healthcare organization can maintain existing performance levels. In examples where a center of a circle 808 falls on one or both of the axes 802, 804, then one or more decisions may be recommended by the scatter plot 800, requiring further examination by the decision-makers of the healthcare organization. As shown in the example of FIG. 8, the healthcare organization needs to fix or improve the sub-capability 304 of first available appointment, to differentiate the sub-capability 304 of provider reviews, to hold off on affecting the sub-capability 304 of proactive notifications, and to maintain a performance level of the sub-capability 304 of multi-channel options.

In alternative implementations, the second, orthogonal axis 804 of the scatter plot 800 may be associated with a performance of a different healthcare organization (e.g., the performance of a competitor of the reference healthcare organization, as opposed to the market performance) such that the origin 806 corresponds (e.g., in a horizontal direction) to the organizational sub-capability rating 316 of the other healthcare organization. In such examples, the horizontal position of a circle 808 reflects a difference between the organizational sub-capability rating 316 of the reference healthcare organization and the organizational sub-capability rating 316 of a competitor of the healthcare organization. Accordingly, the scatter plot 800 can summarize the performance of a first healthcare organization with respect to the performance of a second healthcare organization. In other implementations, the scatter plot summarizes performances of the healthcare organization with respect to capabilities 302 of the healthcare organization.

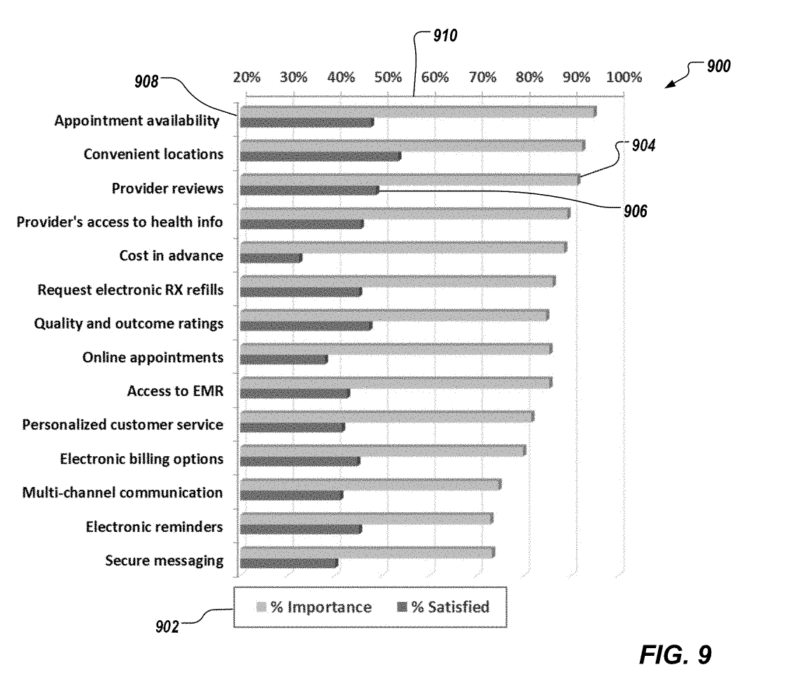

FIG. 9 depicts an example bar graph 900 in accordance with implementations of the present disclosure. The bar graph 900 is generated by the graphing module 214 of the output engine 206 and presents average consumer importance ratings in association with average consumer satisfaction ratings for several sub-capabilities 304 of a healthcare organization (e.g., the reference healthcare organization). The bar graph 900 includes a legend 902 indicating that light colored bars 904 correspond to consumer importance and that dark colored bars 906 correspond to consumer satisfaction in the example of FIG. 9. The bar graph 900 includes a vertical axis 908 listing the sub-capabilities 304 and a horizontal axis 910 providing a measurement scale (e.g., a percentage scale). As shown in the example of FIG. 9, an average consumer satisfaction rating lags an average consumer importance rating for each sub-capability 304 shown. In some examples, the healthcare organization may desire to close such gaps by implementing recommended plans of action.

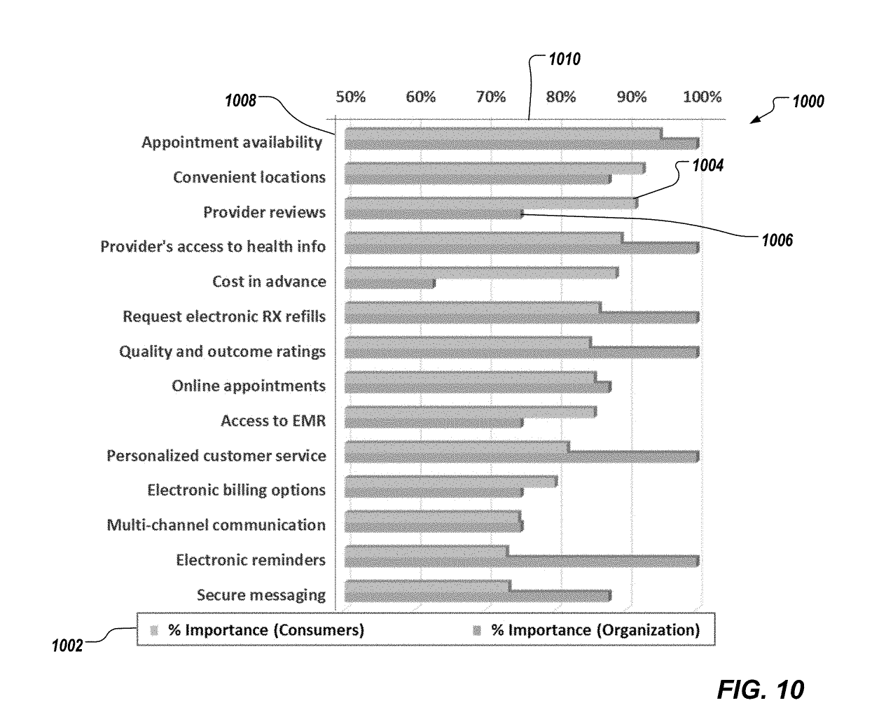

FIG. 10 depicts an example bar graph 1000 in accordance with implementations of the present disclosure. The bar graph 1000 is generated by the graphing module 214 of the output engine 206 and presents average consumer importance ratings in association with average organizational importance ratings for several sub-capabilities 304 of a healthcare organization (e.g., the reference healthcare organization). The bar graph 1000 includes a legend 1002 indicating that light colored bars 1004 correspond to organizational importance and that dark colored bars 1006 correspond to consumer importance in the example of FIG. 10. The bar graph 1000 includes a vertical axis 1008 listing the sub-capabilities 304 and a horizontal axis 1010 providing a measurement scale (e.g., a percentage scale). As shown in the example of FIG. 10, the healthcare organization values some sub-capabilities 304 (e.g., electronic reminders) more than the extent to which consumers value them. In other cases, the consumers values some sub-capabilities 304 (e.g., provider reviews) more than the extent to which the healthcare organization values them. In some implementations, the healthcare organization may decide to shift priorities to more closely examine or improve sub-capabilities 304 where the organizational importance lags the consumer importance.

In some implementations, the output engine 206 of the capability assessment tool 200 outputs one or more graphical outputs (e.g., the graphical outputs 400, 500, 600, 700, 800, 900, 1000) to a computing device (e.g., a computing device 102 of the computing system 100) for display on a processing device to a user of the capability assessment tool 200. That is, the output engine 206 can provide the graphical outputs for presentation in a user interface being presented on a display of the processing device (e.g., for presentation in a web browser or a special-purpose application executing on the processing device and configured to interact with the capability assessment tool 200 over a network). In some examples, the output engine 206 provides a subset of the generated graphical outputs to the processing device based on a user selection of desired graphical outputs. In some examples, the output engine 206 provides all of the generated graphical outputs to the processing device. In some examples, the output engine 206 may receive additional input data in association with one or more of the graphical outputs from the assessment module 208 of the analysis engine 204 and output the additional input data to the computing device. In some examples, the user may be a leader or a decision-maker of a healthcare organization.

In some implementations, the graphical outputs present multiple facets of consumer data in easy to understand formats that allow the user of the capability assessment tool 200 to quickly draw conclusions about where to focus organizational efforts, investment funding, and attention. The multi-faceted nature of the graphical outputs (e.g., accounting for one or more of consumer perspectives, organizational perspectives, and competitive positioning) ensures that the user can make informed decisions based on a comprehensive market analysis. By presenting raw data in a normalized form (e.g., according to the ratings 308, 314, 316, 318, 320, and 322), the graphical outputs provide simplified analyses from which the user can make quick, informed decisions. In some implementations, the information presented in the graphical outputs may lead the user to influence or make decisions such as shifting investments or funding from one or more capabilities or sub-capabilities to one or more other capabilities or sub-capabilities, implementing program changes, offering new services, removing existing services, or maintaining existing services. In this manner, the capability assessment tool 200 provides actionable recommendations that can inform marketing, strategies, technology investments, and service investments of the healthcare organization. Accordingly, the capability assessment tool 200 provides a novel technology that assists decision-making of the user regarding capabilities of the healthcare organization.

Furthermore, in some instances, the capability assessment tool 200 can retrieve processed data within capability scorecards 300 stored in the data repository 202, as opposed to repeatedly retrieving raw data from the data repository 202 and reprocessing such data. In this manner, the capability assessment tool 200 improves the processing speed (e.g., an amount of time required to output a desired result) of the system (e.g., the computing system 100) on which the capability assessment tool 200 is implemented.

In some implementations, new data may be gathered by the healthcare organization following implementation of one or more decisions informed by one or more of the graphical outputs generated by the output engine 206. In some examples, the capability assessment tool 200 may then be used to repeat a previous analysis to generate new graphical outputs that may be compared to previously generated graphical outputs. Such comparisons can provide the user with a measure of the impact of previous assessments provided by the graphical outputs and of decisions informed by such previous assessments.

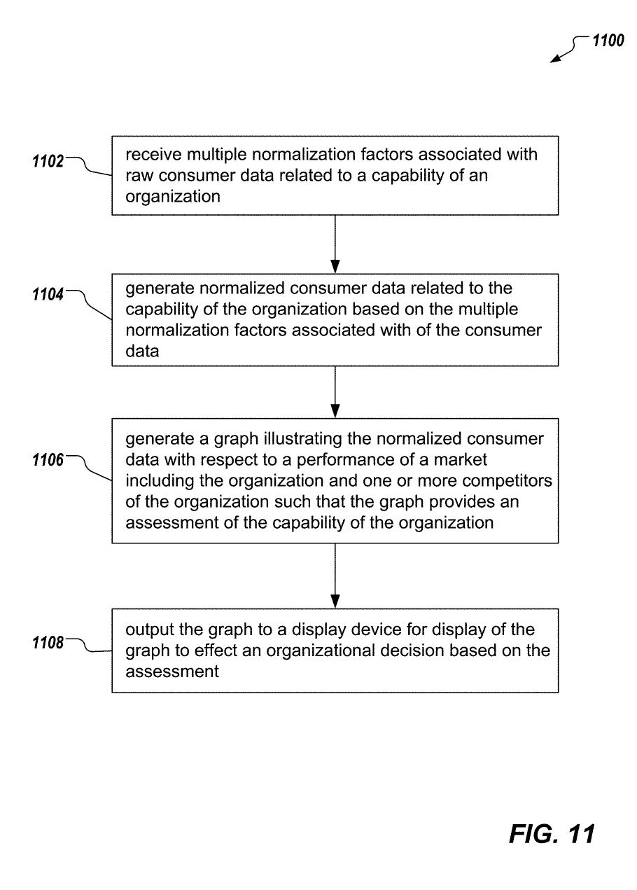

FIG. 11 depicts an example process 1100 that can be performed in implementations of the present disclosure. The example process 1100 can be performed, for example, by the computing system 100 of FIG. 1. In some examples, the example process 1100 can be provided by a system implemented as one or more computer-executable programs on one or more computing devices provided by the server system 104.

Multiple normalization factors associated with raw consumer data related to a capability 302 of an organization are received (1102). For example, multiple KPI ratings 308 of KPIs 306 related to the capability 302 may be received in the evaluation module 212 of the analysis engine 204 of the capability assessment tool 200 from the assessment module 208 or from the transformation module 210. In some examples, the KPI ratings 308 are provided as one or more of integer ratings or percentage ratings of the qualitative consumer data. In some examples, the raw consumer data reflects customer insights gathered from one or more data collection mechanisms including site visits, operational data, executive communications, feedback forms, customer simulations, and primary customer research. In some examples, the capability 302 is a personalization capability, an access capability, a transparency capability, a consumer power capability, a multi-channel capability, or a disintermediation capability. In some examples, the capability 302 includes multiple sub-capabilities 304 that reflect various KPIs 306. In some examples, the organization is a healthcare organization. The raw consumer data may be subjective or objective and qualitative or quantitative.

Normalized consumer data related to the capability 302 of the organization is generated based on the multiple normalization factors associated with the raw consumer data (1104). For example, the multiple KPI ratings 308 may be stored as normalized data within the capability scorecard 300, and various numerical ratings (e.g., organizational sub-capability ratings 316, organizational capability ratings 318, market sub-capability ratings 320, and a market capability rating 322) may be calculated by the transformation module 210 of the analysis engine 204 based on the multiple KPI ratings 308. Accordingly, the transformation module 210 receives the KPI ratings 308 from the assessment module 208. The transformation module 210 may then compute a market (e.g., average) KPI rating 314 across a reference healthcare organization and the competitors of the reference healthcare organization. The transformation module 210 may also compute an organizational sub-capability rating 316 (e.g., as an average of the KPI ratings 308 for a particular sub-capability) for the reference healthcare organization and for each competitor of the reference healthcare organization. The transformation module 210 may also compute an organizational capability rating 318 (e.g., as an average of all of the KPI ratings 308 associated with the capability 302) for the reference healthcare organization and for each competitor of the healthcare organization. The transformation module 210 may also compute a market sub-capability rating 320 (e.g., as an average of all of the organizational sub-capability ratings 316) and a market capability rating 322 (e.g., as an average of all of the organizational capability ratings 318) across the reference healthcare organization and the competitors of the healthcare organization. In some examples, the raw consumer data and the normalized consumer data reflect a first consumer perspective of the organization and a second consumer perspective of the competitor of the organization. The normalized consumer data may be quantitative data.

A graph (e.g., a graph 400, 500, 600, 700, or 800) illustrating the normalized consumer data is generated with respect to a performance of a market including the organization and a competitor of the organization such that the graph provides an assessment of the capability of the organization (1106). For example, any of the graphical outputs 400, 500, 600, 700, or 800 may be generated by the output engine 206. In some examples, an additional one or more graphical outputs 900, 100 may be generated based on additional raw or normalized data within in the data repository 202.

In some examples, the capability 302 is a first capability, the raw consumer data is further related to a second capability 302 and a third capability 302 of the organization, and the normalized consumer data (e.g., the KPI ratings 306, the organizational sub-capability ratings 316, the organizational capability ratings 318, the market sub-capability ratings 320, and the market capability rating 322) is further related to the second and third capabilities 302 of the organization. Accordingly, in some examples, the graph is a polygonal graph 600 or a consolidated scorecard 700 illustrating the normalized consumer data with respect to one or both of the performance of the market and the performance of the competitor of the organization.

Furthermore, in some examples, the normalized consumer data is first normalized consumer data, and second normalized consumer data including consumer importance ratings and consumer satisfaction ratings of the capability 302 of the organization are received in the assessment module 208 of the analysis engine 204. Accordingly, in some examples, the graph is a barometric graph 400, 500 illustrating the first normalized consumer data with respect to the second normalized consumer data and with respect to one or both of the performance the market and a performance of the competitor of the organization.

In some examples, the normalized consumer data is first normalized consumer data (e.g., organizational sub-capability ratings 316), and second normalized consumer data including consumer importance ratings is received in the assessment module 208 of the analysis engine 204. Accordingly, in some examples, the graph is a scatter plot 800 illustrating the first normalized consumer data with respect to the second normalized consumer data and with respect to the performance the market. In some examples, the scatter plot informs one of four organizational decisions including differentiating or growing a sub-capability 304, improving the sub-capability 304, prolonging an improvement of the sub-capability 304, and maintaining a performance level of the sub-capability 304.

In some examples, the second normalized consumer data further includes consumer satisfaction ratings. Accordingly, in some examples, the graph is a first graph, and a second, bar graph illustrating the consumer importance ratings with respect to the consumer satisfaction ratings is generated by the graphing module 214 of the output engine 206. In some examples, the second normalized consumer data further includes organizational importance ratings. Accordingly, in some examples, the graph is a first graph, and a second, bar graph illustrating the consumer importance ratings with respect to the organizational importance ratings is generated by the graphing module 214 of the output engine 206.

The graph is outputted to a display device for display of the graph to a user associated with the organization to effect an organizational decision based on the assessment (1108). For example, information presented in the graph may lead a user viewing the graph to influence or make decisions such as shifting investments or funding from one or more capabilities or sub-capabilities to one or more other capabilities or sub-capabilities, implementing program changes, offering new services, removing existing services, or maintaining existing services. In this manner, the capability assessment tool 200 provides actionable recommendations that can inform marketing, strategies, technology investments, and service investments of the organization.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatuses may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

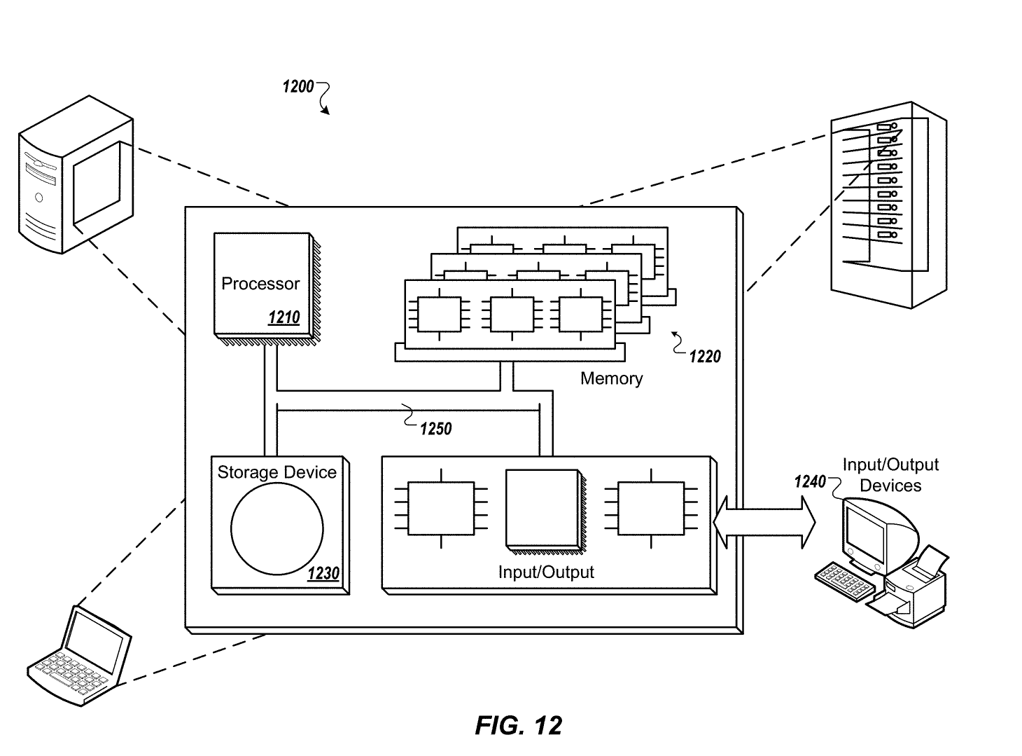

FIG. 12 depicts an example computing system 1200 that can execute implementations of the present disclosure. The computing system 1200 can be used for the operations described in association with any of the computer-implement methods described previously, according to one implementation. The computing system 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the computing system 1200. In one implementation, the processor 1210 is a single-threaded processor. In another implementation, the processor 1210 is a multi-threaded processor. The processor 1210 is capable of processing instructions stored in the memory 1220 or on the storage device 1230 to display graphical information for a user interface on the input/output device 1240.

The memory 1220 stores information within the computing system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the computing system 1200. In one implementation, the storage device 1230 is a computer-readable medium. In various different implementations, the storage device 1230 may be a floppy disk device, a hard disk device, an optical disk device, or a tape device.

The input/output device 1240 provides input/output operations for the computing system 1200. In one implementation, the input/output device 1240 includes a keyboard and/or pointing device. In another implementation, the input/output device 1240 includes a display unit for displaying graphical user interfaces.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for assessing a capability of an organization, the computer-implemented method being executed by one or more processors and comprising:
receiving, by the one or more processors, a plurality of normalization factors associated with raw consumer data related to the capability of the organization;
generating, by the one or more processors, normalized consumer data related to the capability of the organization based on the plurality of normalization factors associated with the raw consumer data;
generating, by the one or more processors, a graph illustrating the normalized consumer data with respect to a performance of a market comprising the organization and one or more competitors of the organization such that the graph provides an assessment of the capability of the organization; and
outputting, by the one or more processors, the graph to a processing device for display of the graph to effect an organizational decision based on the assessment.

2. The computer-implemented method of claim 1, wherein the raw consumer data comprises one or both of subjective data and objective data.

3. The computer-implemented method of claim 1, wherein the raw consumer data comprises one or both of qualitative data and quantitative data.

4. The computer-implemented method of claim 1, wherein the normalized consumer data comprises quantitative data.

5. The computer-implemented method of claim 1, wherein the plurality of normalization factors comprises numerical ratings.

6. The computer-implemented method of claim 5, wherein the numerical ratings comprise one or more of integer ratings of the raw consumer data and percentage ratings of the raw consumer data.

7. The computer-implemented method of claim 1, wherein the capability comprises a personalization capability, an access capability, a transparency capability, a consumer power capability, a multi-channel capability, or a disintermediation capability.

8. The computer-implemented method of claim 1, wherein the organization comprises a healthcare organization.

9. The computer-implemented method of claim 1, wherein the capability comprises a plurality of sub-capabilities that reflect one or more key performance indicators.

10. The computer-implemented method of claim 1, wherein the raw consumer data and the normalized consumer data reflect a first consumer perspective of the organization and a second consumer perspective of the one or more competitors of the organization.

11. The computer-implemented method of claim 10,
wherein the capability is a first capability;
wherein the raw consumer data is further related to a second capability and a third capability of the organization; and
wherein the normalized consumer data is further related to the second and third capabilities of the organization.

12. The computer-implemented method of claim 11, wherein the graph comprises a polygonal graph illustrating the normalized consumer data with respect to one or both of the performance of the market and performances of the one or more competitors of the organization.

13. The computer-implemented method of claim 11, wherein the graph comprises a consolidated scorecard displaying the normalized consumer data with respect to one or both of the performance of the market and a performance of the one or more competitors of the organization.

14. The computer-implemented method of claim 10, wherein the normalized consumer data is first normalized consumer data, the computer-implemented method further comprising receiving second normalized consumer data comprising consumer importance ratings and consumer satisfaction ratings of the capability of the organization.

15. The computer-implemented method of claim 14, wherein the graph comprises a barometric graph illustrating the first normalized consumer data with respect to the second normalized consumer data and with respect to one or both of the performance the market and performances of the one or more competitors of the organization.

16. The computer-implemented method of claim 1, wherein the raw consumer data is first raw consumer data, the computer-implemented method further comprising receiving second raw consumer data comprising consumer importance ratings.

17. The computer-implemented method of claim 16, wherein the graph comprises a scatter plot illustrating the first raw consumer data with respect to the second raw consumer data and with respect to the performance the market.

18. The computer-implemented method of claim 17, wherein the graph informs one of four organizational decisions comprising growing the capability, improving the capability, prolonging an improvement of the capability, and maintaining a performance level of the capability.

19. The computer-implemented method of claim 16, wherein the second raw consumer data further comprises consumer satisfaction ratings.

20. The computer-implemented method of claim 19, wherein the graph is a first graph, the computer-implemented method further comprising generating a second graph comprising a bar graph illustrating the consumer importance ratings with respect to the consumer satisfaction ratings.

21. The computer-implemented method of claim 16, wherein the second raw consumer data further comprises organizational importance ratings.

22. The computer-implemented method of claim 21, wherein the graph is a first graph, the computer-implemented method further comprising generating a second graph comprising a bar graph illustrating the consumer importance ratings with respect to the organizational importance ratings.

23. A non-transitory computer-readable storage medium coupled to one or more processors and having instructions stored thereon which, when executed by the one or more processors, cause the one or more processors to perform operations for assessing a capability of an organization, the operations comprising:
receiving a plurality of normalization factors associated with raw consumer data related to the capability of the organization;
generating normalized consumer data related to the capability of the organization based on the plurality of normalization factors associated with the raw consumer data;
generating a graph illustrating the normalized consumer data with respect to a performance of a market comprising the organization and one or more competitors of the organization such that the graph provides an assessment of the capability of the organization; and
outputting the graph to a processing device for display of the graph to effect an organizational decision based on the assessment.

24. A system, comprising:
one or more processors; and
a computer-readable storage device coupled to the one or more processors and having instructions stored thereon which, when executed by the one or more processors, cause the one or more processors to perform operations for assessing a capability of an organization, the operations comprising:
receiving a plurality of normalization factors associated with raw consumer data related to the capability of the organization,
generating normalized consumer data related to the capability of the organization based on the plurality of normalization factors associated with the raw consumer data,
generating a graph illustrating the normalized consumer data with respect to a performance of a market comprising the organization and one or more competitors of the organization such that the graph provides an assessment of the capability of the organization, and
outputting the graph to a processing device for display of the graph to effect an organizational decision based on the assessment.
